(19) United States
(12) Patent Application Publication
(10) Pub. No.: US 2007/0248936 A1
(43) Pub. Date: Oct. 25, 2007

(54) METHOD AND ARRANGEMENT FOR TEACHING ACCOUNTING PRINCIPLES VIA GAME-PLAY

(76) Inventor: Steve Huff, Fairfield, CT (US)

Correspondence Address: NOVAK DRUCE & QUIGG, LLP, 1300 EYE STREET NW, SUITE 1000 WEST TOWER, WASHINGTON, DC, 20005, US

(21) Appl. No.: 11/550,657

(22) Filed: Oct. 18, 2006

Related U.S. Application Data
(60) Provisional application No. 60/596,741, filed on Oct. 18, 2005.

(51) Int. Cl. G09B 19/18

(52) U.S. Cl. 434/109

(57) ABSTRACT

Method and arrangement for teaching and practicing accounting transactions. The method is performed as an adjunct to playing a game that is based, at least in part, on financial transactions. Students engage in the play of a game in which simulated financial transactions are performed and recorded into a balance-requiring worksheet as a dual-entry. The balance-requiring worksheet includes asset and expense accounts balancing against liabilities, equity, and revenue accounts. In one embodiment of the invention, the game played is the MONOPOLY game. A human moderator or teacher is normally utilized to check the accuracy of the accounts into which the players record each of the two component entries of the dual-entry.

### CROSS-REFERENCE TO RELATED APPLICATIONS

This application claims priority under 35 U.S.C. § 119(e) to the U.S. Provisional Patent Application No. 60/596,741 filed on Oct. 18, 2005, the entire contents of which are hereby incorporated by reference.

### FIELD

The present invention relates to methods for teaching persons financial accounting principles, including proper transactional entries, as well as reading and understanding traditional financial statements. More specifically, the present invention relates to teaching methods in which the MONOPOLY game is played, and the financial transactions made during the course of play are entered into an automated spreadsheet on more intuitive bases than traditional debits and credits, and heretofore complicated conventional financial statements are derived therefrom, thereby illustrating such statements' compilation in a simplified and understandable manner.

### BACKGROUND

Traditional principles of accounting oftentimes prove to be complicated and hard to learn by the novice. Among other reasons, the terms “debit” and “credit” are used in special ways that are not always intuitive to a lay person unschooled in such principles. Oftentimes, not only are the definitions and uses of these terms different, but actually represent opposite concepts then would be expected by the lay person. As can be expected, these inconsistencies present substantial obstacles to the learning of the more academic accounting principles, as well as the financial statements that are based thereupon and which are critical for even the lay person to understand. For these reasons, the need for a simplified method for teaching basic accounting principles, as well as the reading of traditional financial statements, can be easily appreciated. The present invention provides just such a method.

### SUMMARY

In a general sense, the present invention provides a simplified and entertaining method for teaching accounting. In the context of the present disclosure the method encompasses at least the making of account entries and generating and reading financial statements, in an intuitive way without any requirement that the participants have an extensive knowledge of the use of debits and credits, as would be required with conventional education in accounting principles. The method involves the recordation of simulated financial transactions into a worksheet that enables the calculation of account balances. The method also utilizes game play, which provides for the organization of participants or pupils into teams. This team approach reinforces interactive learning, idea sharing, and concept discussion among team members who are learning accounting while playing a MONOPOLY-based game.

A primary audience for this invention is the busy executive that has not been formally educated in accounting principles in that it provides an overview of accounting and either delivers or enhances the skill set of the participant to both understand and prepare financial statements including profit and loss (P & L) balance sheets, and cash flow statements.

The inventive teaching method also accommodates ongoing career development for participants, as well as stimulates both an interest and capability to more effectively use finance statements. The invention also serves as a bridge that naturally leads to future development of other financial concepts through higher “levels” of the game.

As with all games, and especially teaching games, the participants must want to play; to that end, the present invention provides for delivery of education in finance and accounting in an entertaining way via interactive team game play. The participant, typically an executive as described above, is taught what specific accounting terms and concepts mean, plus how to use them in a “hands on” way by a process that de-mystifies heretofore alien financial and accounting concepts, while translating and/or analogizing technical accounting terms into ones more immediately understood and usable vocabulary. Ultimately, the inventive teaching process “grounds” the non-technical individual in accounting and financial principles.

In at least one embodiment, the invention teaches the player what “cash flow” really is from a practical stand point, and how it works in conjunction with the concepts of “profitability” and “assets, liabilities, and equity” thereby grounding the pupil in accounting principles without necessarily requiring the individual to understand the somewhat cumbersome concepts of “debits and credits.”

As is explained in greater detail herein, the included game worksheets of a preferred embodiment of the invention are color-coded, with a different color for each of the categories for assets, liabilities, equity, revenue, and expense. This color-coding feature facilitates the students' learning and remembering of the several different financial categories and the individual accounts that make each up. For consistency, this color-coding is the same format used during practice exercises that lead up to game play.

In at least one embodiment, the game worksheets are automated for computer and laptop play, utilizing the same color-coding schemes. In this way, it is easy for the students to practice and play the learning game in the computer environment, including on personal computer(s). One particular benefit of computer-based play is that it eliminates the need to use a calculator during team play to arrive at financial category and account totals.

To boost enthusiasm, the game is made competitive via a predetermined formula that determines a winner among the teams or individuals. Exemplarily, the winner-designating formula can be based upon both profitability and cash flow concepts considering the teams' management thereof during play. A general objective of the inventive accounting teaching method of the present invention can be characterized as the provision of a fun, intuitive way for students to learn accounting concepts, including related financial statements at least partially through game play.

In at least one embodiment, the invention takes the form of a method for teaching and practicing accounting transactions. The method is performed as an adjunct to playing a game that is based, at least in part, on financial transactions, while avoiding the confusion of traditional debit and credit accounting entry classifications. To this end, the method comprises (includes, but is not limited to the recited steps, which may, but are not required to be in the recited order) engaging in the play of a game in which simulated financial transactions are performed by at least one player. From this, recordings of at least one of the performed simulated financial transactions are made into a balance-requiring worksheet as a dual-entry. In this respect, the dual-entry concept is borrowed from traditional accounting in that for each transaction, at least two entries must be made in what could be considered an action and reaction context; that is, every action that is taken in a financial transaction (one recordation in an account) must have a balancing or compensating reaction evidenced by at least one corresponding entry in one or more different account(s). In this regard, the balance-requiring worksheet includes asset and expense accounts balancing against liabilities, equity and revenue accounts. For purposes of convention in the description contained herein, the asset and expense accounts will be considered to be on one side, preferably the left side “of the line” with the liabilities, equity and revenue accounts on the opposite side, preferably the right side “of the line.”

In a particularly preferred embodiment of the invention, the game to be played is selected to be the MONOPOLY game.

After a transaction has been recorded, the accuracy of the recorded dual-entry is checked by taking a difference between each of two component entries (account entries) of the dual-entry when one component entry is in the asset or expense accounts (left side of the line), and the other component entry is in the liabilities, equity or revenue accounts (right side of the line). It should be appreciated that for purposes of the present disclosure, the more alien-to-the-layman terminology of “account” as been genericized to “category” or “account category” within which the traditional accounts of assets, liabilities, expenses, equity and revenue are constituent components. Alternatively, a summation is made of each of the two component entries of the dual-entry when both component entries are in the asset or expense account (left side of the line) or when both component entries are in the liabilities, equity or revenue accounts (right side of the line). From this, an indication of accuracy of the dual-entry is provided when the summation or difference equals zero and an indication of an error in the dual-entry is provided when the summation does not equal zero. These calculations are said to give an indication of accuracy or error because the computed numbers do not confirm that the entries have been made in proper accounts.

Therefore, in a further embodiment, means for checking the accuracy of the accounts into which the player(s) records each of two component entries of the dual-entry is also provided. In a preferred embodiment, a human moderator is provided who constitutes the means for checking the accuracy of the accounts into which the at least one player records each of the two component entries of the dual-entry. It is, however, contemplated that the accuracy-checking means can be automated, for instance, in games where transactions are selected from an array of possible transactions that are known by a controlling system. Therefore, when a known or prescribed entry is recorded by a player, the accuracy of the recordation may be automatically checked.

To facilitate the teaching aspect of the invention, feed-back is provided to the player regarding the results of the check on accuracy of the recorded dual-entry.

If an error is detected, the player re-records the dual-entry. This re-recorded dual-entry is re-checked for accuracy, and the player is again provided feed-back regarding the results of the re-check on accuracy of the re-recorded dual-entry. The steps of re-recording and rechecking can be repeated until the re-check step determines an indication of accuracy of the dual-entry.

A preferred embodiment of the invention affects the recordation of the simulated financial transactions into a pre-programmed computerized spreadsheet that automates treatment of the dual-entries, post-recordation.

Heretofore, the invention has been described in terms of a single transaction for purposes of establishing possible scope of the claimed invention. A preferred embodiment of the invention, however, encompasses the recording, each as dual-entries, of a plurality (more than one) of performed simulated financial transactions into the balance-requiring worksheet. In the instance of multiple recorded transactions, however, accuracy, post-entry, of the plurality of recorded dual-entries is checked by summing the asset and expense account entries and figuring a difference of that summation against a summation of the liabilities, equity and revenue account entries.

From this check, an indication of accuracy of the plurality of recorded dual-entries is provided when the summation equals zero and an indication of error in the checked plurality of recorded dual-entries is provided when the summation does not equal zero.

As in the instance of a single entry, the player(s) can be provided feedback on the accuracy of their transaction recordations, and if inaccuracies are indicated, reattempts can be made at proper recordation until such is achieved.

As intimated above, a unique aspect and primary benefit of the present invention is that the traditional classifications of debits and credits are not utilized. In their place, rules for recordation include assigning a positive sign to an asset component of a recorded dual-entry when the magnitude of the account in which the entry is being made has been increased by the corresponding simulated financial transaction. A negative sign is assigned to an asset component of a recorded dual-entry when the magnitude of the account in which the entry is being made has been decreased by the corresponding simulated financial transaction. Alternatively, regarding signage of entries, the inventive teaching method generally prescribes the assignment of a positive sign to increases in “left-side” components (assets and expenses) while a negative sign is assigned to decreases. Further, a positive sign is given to increases in “right-side” components (liabilities, equity, and revenue) while a negative sign is given to decreases.

In an associated aspect, a positive sign is assigned to an expense component of a recorded dual-entry when the magnitude of the account in which the entry is being made has been increased by the corresponding simulated financial transaction, while a negative sign is assigned to an expense component of a recorded dual-entry when the magnitude of the account in which the entry is being made has been decreased by the corresponding simulated financial transaction.

In still a further associated aspect, a positive sign is assigned to a liability component of a recorded dual-entry when the magnitude of the account in which the entry is being made has been increased by the corresponding simulated financial transaction, a negative sign is assigned to a liability component of a recorded dual-entry when the magnitude of the account in which the entry is being made has been decreased by the corresponding simulated financial transaction.

In yet a further associated aspect, a positive sign is assigned to a revenue component of a recorded dual-entry when the magnitude of the account in which the entry is being made has been increased by the corresponding simulated financial transaction, while a negative sign is assigned to a revenue component of a recorded dual-entry when the magnitude of the account in which the entry is being made has been decreased by the corresponding simulated financial transaction.

In furtherance of the goal of familiarizing students with, and teaching them to read traditional financial statements, the pre-programmed computerized spreadsheet is configured to calculate a balance sheet comprising summations of: (1) asset accounts produced from the recordations of the plurality of dual-entries; (2) liability accounts produced from the recordations of the plurality of recorded dual-entries; and (3) equity accounts produced from the recordations of the plurality of recorded dual-entries. In this manner, the present invention illustrates, through game play, the formulation of a balance sheet as known in traditional finance, the environment within which all business persons must operate.

As a compliment, the pre-programmed computerized spreadsheet is configured to calculate a profit and loss statement comprising a net profit calculated as a difference of a summation of the revenue accounts produced from the recordations of the plurality of dual-entries and a summation of equity accounts produced from the recordations of the plurality of recorded dual-entries.

As a further compliment, the pre-programmed computerized spreadsheet is configured to calculate a cash flow analysis from the recordations of the plurality of dual-entries.

As an enhancement to the selection of the game to be played being the MONOPOLY game, one embodiment of the present invention contemplates a plurality of players being divided onto teams, each of which are allotted a predetermined beginning amount of MONOPOLY game dollars. Play of the MONOPOLY game is initiated thereby giving rise to the execution of simulated financial transactions. Each such simulated transaction is entered into the pre-programmed computerized spreadsheet.

After some period of play, a winner of the MONOPOLY game can be determined based on calculations and a comparison, via the pre-programmed computerized spreadsheet, of net profit for each team. Alternatively, the winner may be determined based on a determination of cash flow produced via being recorded MONOPOLY game transactions.

### BRIEF DESCRIPTION OF THE DRAWINGS

Accompanying drawings are provided as illustrations of exemplary embodiments of inventions according to the present teachings, wherein:

FIG. 1 is a print of a filled-in preprogrammed computerized spreadsheet containing a plurality of MONOPOLY game transactions by one team described as Team A;

FIG. 2 is a print of a trial balance automatically calculated, via the preprogrammed computerized spreadsheet, for Team A;

FIG. 3 is a print of a balance sheet and profit & loss statement, each automatically calculated, via the preprogrammed computerized spreadsheet, for Team A;

FIG. 4 is a print of a cash flow analysis automatically calculated, via the preprogrammed computerized spreadsheet, for Team A;

FIG. 5 is a print of a filled-in preprogrammed computerized spreadsheet containing a plurality of MONOPOLY game transactions by another team described as Team B;

FIG. 6 is a print of a trial balance automatically calculated, via the preprogrammed computerized spreadsheet, for Team B;

FIG. 7 is a print of a balance sheet and profit & loss statement, each automatically calculated, via the preprogrammed computerized spreadsheet, for Team B;

FIG. 8 is a print of a cash flow analysis automatically calculated, via the preprogrammed computerized spreadsheet, for Team B;

FIG. 9 is a print of a filled-in preprogrammed computerized spreadsheet containing a plurality of MONOPOLY game transactions by another team described as Team C;

FIG. 10 is a print of a trial balance automatically calculated, via the preprogrammed computerized spreadsheet, for Team C;

FIG. 11 is a print of a balance sheet and profit & loss statement, each automatically calculated, via the preprogrammed computerized spreadsheet, for Team C; and

FIG. 12 is a print of a cash flow analysis automatically calculated, via the preprogrammed computerized spreadsheet, for Team C.

### DETAILED DESCRIPTION

The objectives and characteristics of the invention are detailed hereinabove; the following disclosure describes an exemplary embodiment of the teaching game, as well as several rounds of play of the game, including the recordation of representative worksheet entries, that as explained above, may be of a manual nature or an automated nature on a computing device that facilitates automated “crunching” of the numbers. Regarding either recordation mode (manual or electronic), reference is made in the following description to the accompanying Figures wherein the outcome of the playing of one game is demonstrated.

In the illustrated example, three teams have been formed, exemplarily with 6 persons to a team. The teams are designated A, B, and C. As explained hereinabove, the use of team play reinforces learning, idea sharing, and concept discussion during the game. Each team selects a captain who will generally roll the game dice and coordinate decision-making.

The rules of the MONOPOLY game have been modified or provided with adjunct rules, that, according to the invention, facilitate the teaching of accounting and the financial statements. The principle modifications can be summarized as follows: (1) When a team lands on the Luxury Tax space of the game board ($75 due), no cash payment is required until that team next rolls doubles. This enables the recording of an “account payable” liability component (account), and its subsequent elimination when the payment is made. Accounts payable are not conventionally allowed in the MONOPOLY game. (2) Any team may borrow from any other team or from the bank. Interest rates are negotiated between the teams. The bank sets a rate at the beginning of the game. These rules facilitate the recording of transactions to loans receivable, loans payable, and interest expense accounts to enhance the learning of accounting. Such loan transactions are not contemplated in the MONOPOLY game. (3) A team may purchase get-out-of-jail insurance from the bank. For example, this can cost twenty-five dollars, and expires after three trips around the board. This rule facilitates the recording of a Prepaid Insurance asset component, and its expiration to an expense component. This option is not available in the MONOPOLY game. (4) At the outset of game play, an additional amount of $750 is given to each team, over and above the $1500 normally prescribed at the start of the MONOPOLY game. This is called the “Pre-Buy” phase. This phase is not part of the MONOPOLY game. This additional amount is used to get the game going faster and to stimulate more transactions. During the Pre-Buy phase, each team takes a turn, in rotation, without actually rolling the dice, and can use that turn to either purchase a property or pass. These turns continue until the $750 is spent by all teams, and/or no properties can be acquired with the remaining unspent portions of the $750 allotments. In this way, property is acquired prior to actually beginning formal play of the MONOPOLY game. It is possible for one team to purchase a block of property with its $750 (all properties owned of the same color, which can be later developed by purchasing houses and hotels) unless another team breaks up this acquisition by purchasing one before the other team gets a chance to buy them all. It should be appreciated that the specific aspects of the Pre-Buy phase of play pursuant to the teachings of the invention can be readily modified; for example, the amount can be increased from $750 to $1,250 without changing any of the basic descriptions provided above. (5) At any point in the game, a team knows its cash balance without having to count the cash. The balance will always be equal to the total of all amounts written or entered in the column for the Cash asset component of the Worksheet as emerge from the description of play hereinbelow. This feature helps in checking the accuracy of the entries, in that the cash component total on the worksheet at any point during the game, or at the end of the game, must match the actual cash amount when it is counted. In fact, the amount spent or accumulated for any other components such as Land, Houses, Hotels, Revenue and the like will also be equal to the total of all amounts written or entered in the corresponding column of the Worksheet. This aspect or feature can be used to “quantify” each team's relative degree of success, compared to the others, both during and after the game.

In one important aspect of the invention, basic accounting logic has been converted into algebra, eliminating the need for the concept of “debits” and “credits.” According to the invention, this logic is called the Accounting Equation; the associated Worksheets that are evidenced in the accompanying drawings demonstratively illustrate this accounting logic wherein Assets+Expenses (Left Side)=Liabilities+Equity+Revenue (Right Side). The shorthand notation for the Accounting Equation is: A+E=L+Q+R; where A=Assets, E=Expenses, L=Liabilities, Q=Equity, and R=Revenue.

Further, the categories are color-coded. Exemplarily, Assets carry a BLUE background, Expenses YELLOW, Liabilities PINK, Equity VIOLET, and Revenue GREEN.

The entries and worksheet are adapted to be compatible with play of the MONOPOLY game. Below are the components (accounts) that are used for each category, with a reference for a corresponding account from traditional accounting.

| | |
|---|---|
| The Invention: | Traditional Accounting: |

Assets (BLUE)

| | |
|---|---|
| Cash | Cash |
| Land | Land |
| Buildings | Property, Plant and Equipment or |
| | Fixed Assets |
| Loans Receivable | Loans Receivable |
| Prepaid Expenses | Prepaid Expenses |
| Mortgaged Property | N/A |

Expenses (YELLOW)

| | |
|---|---|
| Rent Expense | Rent Expense |
| Interest Expense | Interest Expense |
| Other Expense | Individual expense accounts |
| (includes jail, | |
| utilities, community chest) | |

Liabilities (PINK)

| | |
|---|---|
| Accounts Payable | Accounts Payable |
| Loans Payable | Loans Payable |

Equity (VIOLET)

| | |
|---|---|
| Equity | Retained Earnings or Paid-in-Capital |

Revenue (GREEN)

| | |
|---|---|
| Rent Revenue | Rent Revenue |
| Go Revenue | N/A |
| Other Revenue | Individual revenue accounts |

From this, it may be appreciated that the “shorthand” notation of A+E=L+Q+R is very useful for understanding accounting and is therefore now explained further. A positive sign is given to entries signifying increases in Left Side components within the assets and expenses categories, while a negative sign is given to Left Side component entries representative of decreases. Further, a positive sign is given to increases in Right Side components (within liabilities, equity, and revenue categories) while a negative sign given to decreases in Right Side components.

Positive and negative signage for increases and decreases in components (accounts) are much more intuitive for understanding changes in money than are the often time counter-intuitive traditional concepts of “debits” and “credits” from conventional accounting principles. The individual simply has to remember Left Side vs. Right Side rules in order to make correct dual-entry transactions. It should be noted that each transaction must have a minimum of two entries, but can have more than two, as would be the instance of a mortgage financed property purchase. The following micro-checks may be utilized on a transactional level: (1) the sum of entries in a transaction that affects only the Left Side must equal zero; (2) the sum of entries in a transaction that affects only the Right Side must equal zero; and (3) if a single transaction affects both the Left and Right Side (dual-sided transaction), the sum of the Left Side amounts must equal the sum of the Right Side amounts. Or, alternatively stated, the difference between the Left Side and Right Side totals must equal zero.

The afore-mentioned shorthand notation for transactions is now also simple to understand, and is intuitive.

Shorthand Notation for Left-Side Transactions:

If a team spends cash and purchases property, in accounting this transaction is a “credit” to Cash and a “debit” to Land. According to the present invention's Accounting Equation, this transaction is instead recorded simply as −Cash, +Land (Left-Side). Since both Cash and Land are in the Assets (A) category, it can be appreciated that −A, +A can be representative thereof, and the sum equals zero for the valid transaction. This “shorthand” method of understanding a transaction helps to guarantee its understanding by the non-technical, or at least non-financial person.

In traditional accounting, if a cash payment is received that creates revenue, that is recorded as a “debit” to cash and a “credit” to revenue. At a minimum, it can be appreciated that a debit to cash is counter-intuitive to the layperson when receiving cash. In the invention's Accounting Equation, however, this transaction is recorded simply as +Cash, +Revenue; Cash is Left-Side, Revenue is Right-Side. And the difference between the totals for the two sides must equal zero (Left-Side=Right-Side) for a valid transaction. Especially for the person being introduced to accounting principles and financial statements, it is much easier to conceptualize a +Cash transaction as increasing cash than it is to “debit” Cash. The same is true for increasing revenue as +Revenue, rather than a “credit” to Revenue.

Other Left-Side Transactions include: (1) Spending cash and paying rent (−Cash, +Rent Expense) or −A, +E; (2) Spending cash and buying houses or hotels (−Cash, +Buildings) or −A+A; (3) Spending cash and buying jail insurance (−Cash, +Prepaid Expense) or −A+A.

Pure Right Side Transactions are uncommon; in that such transaction do not further facilitate the teaching goals of the present invention, they are not further described, and are avoided in the structured game play.

Dual-sided transactions are alluded to hereinabove, and can probably be said to be the most common type of transactions. In this context, if a team collects rent from another team, both Cash (LS—Left-Side) and Revenue (RS—Right-Side) are increased (+Cash, +Rent Revenue) which can be represented as +A, +R. This is a typical dual-sided (DS) transaction. The sum of the LS equals the sum of the RS, or their difference equals zero for a valid transaction.

Other Dual-Sided Transactions encountered through the game's play include: (1) receiving cash at the start of the game ($1500) and increasing Equity (+Cash, +Equity) or +A, +Q; (2) going past “Go” and collecting $200 (+Cash, +Go Revenue) or +A, +R; (3) creating an Account Payable (+Expense, +Account Payable) or +E, +L; (4) paying off an Account Payable (−Cash, −Account Payable), or −A, −L; paying off a loan (−Cash, −Loans) or −A, −L; and creating a loan (+Cash, +Loans) or +A, +L.

It should be noted that if one team collects rent from another, the “collecting” team has a dual-sided transaction while the “paying” team has a left-sided transaction. The teams can see this in “real play,” which further enhances learning of basic accounting concepts.

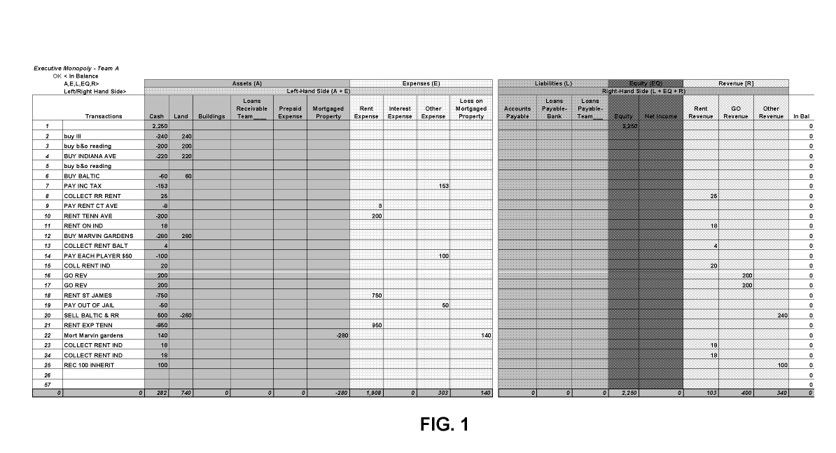

For purposes of exemplifying game play, reference is made to accompanying FIGS. 1, 5 and 9 which represent team accounting worksheets in the form of computerized spreadsheets for Teams A, B and C, respectively. Initially, the pre-buy phase is undertaken as described above. As is evidenced by the worksheets, first, each team records the cash provided to start the game in the amount of $2250 which is calculated based on $1500 which is normally allotted in the MONOPOLY game, plus $750 of Pre-Buy bonus money allotted according to prescription of the present invention. During the Pre-Buy phase, each team can spend only the $750 in bonus money. If a prospective purchase would result in cumulatively spending more than the $750 maximum amount, that purchase cannot be made. When all teams are either unable or unwilling to make additional purchases, the Pre-Buy phase ends and any unspent cash remains in the team's Cash account.

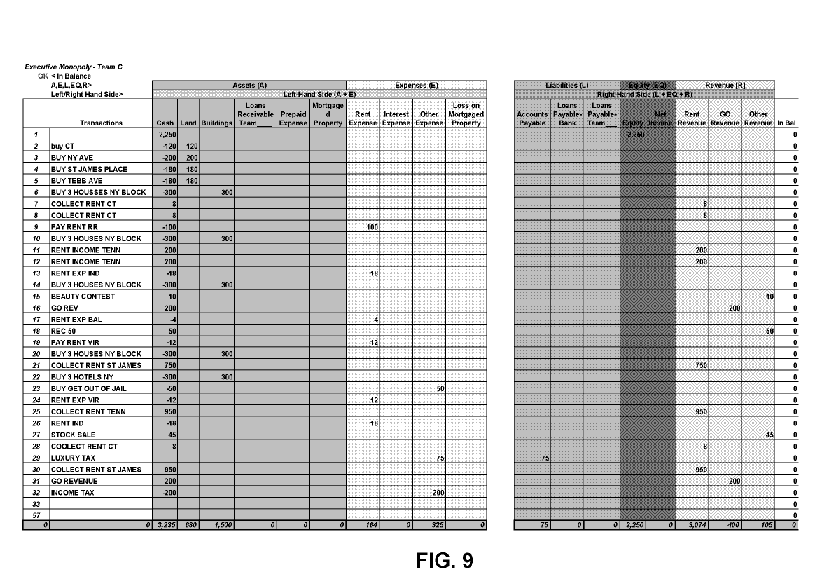

Each team captain then rolls the dice to determine the order of turns in the Pre-Buy phase as described hereinabove. In the example, Team C goes first (no dice are thrown) and purchases Connecticut Ave ($120). They give $120 to the bank and get the Connecticut Ave deed. Each team member then records the transaction on the Team C computerized spreadsheet (FIG. 9). The specific transaction is first recorded in the Description field (“Buy CT Ave”). The amounts are then recorded in dual-entry format as a −$120 in the blue asset account entitled “Cash” and a +$120 is entered in the blue asset account called Land (undeveloped properties are called Land). This transaction is defined as a “left-side” (LS) transaction according to the invention because both entries are made on the left-hand side of the accounting equation. As such, the sum of the two entries must be equal zero.

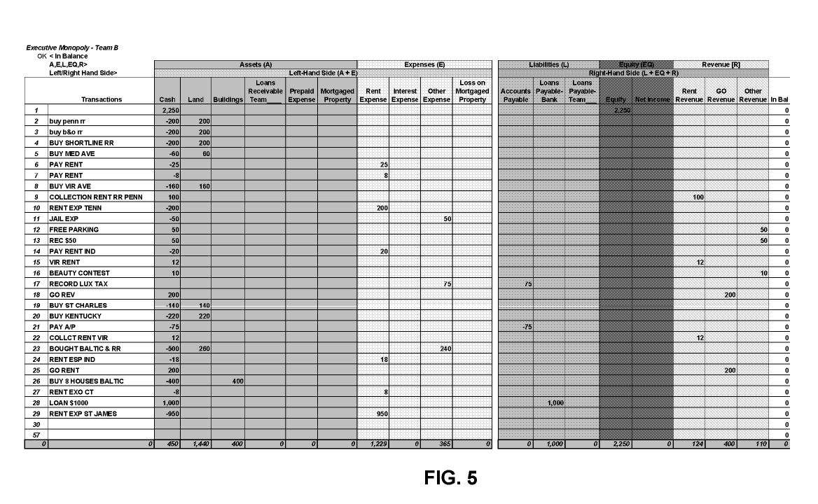

In the illustrative example, Team A then buys Illinois Ave for $240 (−$240 Cash and +$240 Land, LS). This transaction can be seen on the Team A computerized spreadsheet of FIG. 1. Next, Team B buys Pennsylvania Railroad for $200 that can be followed on the Team B computerized spreadsheet of FIG. 5. In the remainder of the present description, the three computerized spreadsheets can be referenced for all transactions subsequently discussed.

In the course of the next three Pre-Buy turns, Team C gains a significant advantage through the purchase of New York ($200), St. James ($180), and Tennessee Ave ($180), all of which are orange color and represent a block that can be developed. Teams A and B discover what Team C is doing, but neither has enough money on their final Pre-Buy turn to block Team C by purchasing Tennessee Ave before Team C gets the chance. Along with Connecticut Ave mentioned earlier, Team C spends a total of $680 in the Pre-Buy phase and only $70 of their Pre-Buy bonus money remains unspent in their Cash account. With each purchase, Team C records a transaction; e.g., for New York the transaction is −$200 Cash and +$200 Land. The other transactions are similar, but for a different amount each time depending on the property purchase price as is evidenced in the teams worksheet. The sum of all of these transactions equals zero since they are all left-side (LS) transactions.

Team A is able to Pre-Buy Illinois Ave ($240), Reading Railroad ($200), Indiana Ave ($220), and Baltic Ave ($60). Team A therefore spends $720 and records negative Cash entries along with positive Land entries (LS) for each purchase with the sum of all these entries totaling zero. Two of these properties are in a red block, but Team A is not able to by the third one. A total of $30 of their Pre-Buy bonus money is not spent.

Team B Pre-Buys three Railroads: Pennsylvania, B & O, and Shortline for $200 each, evidencing a conscious strategy to increase the collectible rent which goes up when multiple railroads are owned according to the rules of the MONOPOLY game. Additionally, Team B buys Mediterranean Ave ($60) which blocks Team A from owning the purple block (Baltic and Mediterranean). Team B spends $660, and a total of $90 of their Pre-Buy bonus money is not spent. This ends the Pre-Buy Phase and regular game play begins according to the invention.

Team C begins regular play, and on its first turn immediately purchases three houses to develop the orange block it now owns. Each house costs $100, and one is placed on each of their owned properties which include New York, St. James, and Tennessee Avenues. Team C now has a solid advantage with respect to properties having the prospect for generating income. The transaction is recorded as −$300 Cash (cash is spent) and +$300 Buildings (Houses are purchased), a LS transaction which sums to zero.

In an unfortunate start, Team A, in the next turn, lands on Income Tax and must pay $153. Team A records transactions of −$153 in the Cash account and +$153 in the Other Expense account, both of which are left-side (LS) accounts in that Income Tax is an expense, paid for with cash.

Team B lands on Reading Railroad, owned by Team A, and accordingly must pay Team A $25 in Rent. Team B does so, and records −$25 Cash and +$25 Rent Expense (LS trans). Team A records an “opposite” but mirror image transaction: +$25 Cash and +$25 Rent Revenue. This transaction includes one left-side account (Cash) and one right-side account (Revenue), and as such, the difference between the two (rather than the sum) must total zero since they are opposite side accounts. All of these transactions quickly take place before Team C again throws the dice for its second turn.

Team C rolls and moves along the MONOPOLY game board, but no transaction takes place just as is common in regular play of the MONOPOLY game. Eventually, Team A lands on Connecticut Avenue, now owned by Team C. The rent is $8. Team A pays this to Team C and records transactions of −$8 Cash and +$8 Rent Expense (LS). Team C records +$8 Cash and +$8 Rent Revenue (DS trans).

Team B takes its turn and also lands on Connecticut Avenue, duplicating the entries above. Team B rolled doubles, and therefore goes again. Team B lands on Virginia Ave (purple block) and buys it as is evidenced by the transactions: −Cash $160, +Land $160 (LS).

Team C rolls the dice and lands on Pennsylvania Railroad, one of three owned by Team B. The rent, because three are owned, is $100 which is paid by Team C to Team B. Team C records −$100 Cash and +$100 Rent Expense (LS) transactions, while Team B documents +$100 Cash and +$100 Rent Revenue (DS). Team C also purchases three more houses on the orange block for $100 each: −$300 Cash+$300 Buildings (LS)

Team A rolls and has bad luck, landing on Tennessee Avenue which is owned by Team C and now has 2 houses on it. The rent with “two houses” is $200. Team A records −$200 Cash and +$200 Rent Expense (LS). Team C records +$200 Cash and +$200 Rent Revenue (DS).

Team B now is unlucky. It rolls and lands on Tennessee Avenue, the same bad luck as Team A! Team C is pulling in the cash based on their wise investments in the Pre-Buy Phase; in this instance, the transaction is recorded by Team B as −$200 Cash+$200 Rent Expense (LS) and by Team C as +$200 Cash, +$200 Rent Revenue (DS).

Team C now lands on Indiana Ave, owned by Team A, but Team A only owns two of the red block, not all three, and therefore the rent is only $18. The transaction for Team C is −$18 Cash, +$18 Rent Expense (LS) and for Team A: +$18 Cash, +$18 Rent Income (DS).

Team A rolls and lands on Marvin Gardens in the yellow block. None of these properties are owned. Team A buys it for $280 (−$280 Cash, +$280 Land, both LS)

Team B lands in jail, but pays $50 to get out. −$50 Cash, +$50 Other Expense (LS). Jail cash is put into the middle for Free Parking. Team B rolls, moves out of jail, and lands on the Free Parking Square and recovers the $50. Team B: +$50 Cash, +$50 Other Revenue. For this transaction, Team B has no change in cash resulting from going into jail, but has added a $50 Revenue and a matching $50 expense in the above two transactions.

In the course of play, Team C continues making improvements. It buys three more houses on the orange block for $100 each. −$300 Cash, +$300 Buildings. Team C now has three houses on each property in the orange block. Team C lands on Community Chest and receives $10 in Cash (+$10 Cash, +$10 Other Revenue) (DS). Team C rolls doubles, and moves again. It goes around GO and collects $200. This is recorded as +$200 Cash, +$200 Go Revenue (DS). Team C lands on Baltic Ave which is owned by Team A and carries with it Rent of $4. Team C: −$4 Cash, +$4 Rent Expense (LS) and Team A: +$4 Cash, +$4 Rent Income (DS).

Team A continues to be unlucky, and lands on Chance/Community and must pay each of the other two teams $50 each. Team A: −$100 Cash, +$100 Other Expense (LS); Team B: +$50 Cash, +$50 Other Revenue (DS); and Team C: +$50 Cash, +$50 Other Revenue (DS).

Next, Team B lands on Indiana Ave, owned by Team A. The rent is $20. Team B: −$20 Cash, +$20 Rent Expense (LS); Team A: +$20 Cash, +$20 Rent Income (DS).

Team C then rolls and lands on Virginia Ave, owned by Team B. Rent is $12. Team C: −$12 Cash, +$12 Rent Expense (LS) and Team B: +$12 Cash, +$12 Rent Income (DS).

Team A now rolls doubles and passes Go, receiving $200. +$200 Cash, +$200 Go Revenue. On their next roll, Team A lands on Chance/Community and is told to advance to a property which is not owned, and again Team A passes Go earning another $200 resulting in the same transaction of +$200 Cash, +$200 Go Revenue constituting a quick $400 to Team A. From the game perspective, it appears their luck may be changing.

Next, Team B lands on Chance/Community and wins a $10 Beauty Contest: +$10 Cash, +$10 Other Revenue (LS). Because Team C is never satisfied, they buy three more houses on the orange block for $100 each. −$300 Cash, +$300 Buildings (LS). Team C now owns four houses, each on properties in the orange block. This could break the backs of Teams A and B. Team C rolls with no transactions. Next, Team A lands on St. James Place in the orange block and the rent due because of the four houses is $750. Team A must scrape together the cash: Team A: −$750 Cash, +$750 Rent Expense (LS) and Team C: +$750 Cash, +$750 Rent Income (DS).

Team B then rolls doubles and lands on Luxury Tax ($75). This is not cash due, but is an Accounts Payable until Team B rolls doubles next time per the rules of the present invention thereby enabling the practice of transactions involving Accounts Payable which would not be possible according to the regular rules of the MONOPOLY game. Team B records +$75 Other Expense, +$75 Accounts Payable (DS). Team B rolls doubles again, gets Chance/Community and lands on St. Charles Place. The transaction for the collection of the $200 is +$200 Cash, +$200 Go Revenue. Team B then buys St. Charles Place for $140. (−$140 Cash, +$140 Land). Team B must now pay the Luxury Tax. This is recorded −$75 Cash, −$75 Accounts Payable (DS). This transaction eliminates the payable with the cash payment.

Team B throws the dice again and lands on Kentucky Ave. Team B buys Kentucky for $220 (−$220 Cash, +$220 Land).

Never being satisfied, Team C now buys a fifth “house” on each orange block property which constitutes one hotel on each property. According to the rules of the MONOPOLY game, this is the highest development possible, and pays the most rent. Team C rolls, lands in jail, but pays $50 to get out. −$50 Cash, +$50 Other Expense (LS). Team C rolls again, lands on Virginia Ave, owned by Team B and pays Rent of $12. Team C: −$12 Cash, +$12 Rent Expense (LS) and Team B: +$12 Cash, +$12 Rent Income (DS).

Team A lands in jail and must pay to get out: −$50 Cash, +$50 Other Expense (LS). Next, Team A lands on Tennessee Avenue having one hotel, and which is owned by Team C. The rent is $950. Team A cannot pay this amount, but goes into negotiations with Team B. Team A sells Baltic Ave and Reading Railroad to Team B for $500. Team B already owns three railroads and Mediterranean Ave, so it has a big gain from buying Team A's distressed properties.

The recordation of the transactions of the “deal” between Teams A and B takes the following form: Team A: +$500 Cash, −$260 Land (cost of Reading $200, cost of Mediterranean $60), +$240 Other Revenue (DS). Team A gains $240 on the sale. Team B: −$500 Cash, +$260 Land (cost of Reading $200, cost of Mediterranean $60), +$240 Other Expense (DS). Team B has made a strategic decision for the future, but has “overpaid” $240 for the properties. Team A, however, still does not have enough money to pay Team C the $950 rent. So it mortgages Marvin Gardens (value $280) for $140. Team A records +$140 Cash, +$140 “Loss on Mortaged Property (expense), −$280 Land. This is a more complicated left-side (LS) transaction. Then, finally, Team A pays Team C $950 for the rent on Tennessee. Team C: +$950 Cash, +$950 Rent Revenue (DS) and Team A: −$950 Cash, +$950 Rent Expense (LS).

It is now Team B's turn, energized by its recent deal. It lands on Indiana Ave, owned by Team A; the rent is $18. Team B: −$18 Cash, +$18 Rent Expense (LS) and Team A: +$18 Cash, +$18 Rent Income (DS).

Next, Team C lands on Indiana Ave owned by Team A. Team C: −$18 Cash, +$18 Rent Expense (LS) and Team A: +$18 Cash, +$18 Rent Income (DS).

Team C rolls doubles, rolls again, and lands on Chance/Community getting $45. +$45 Cash, +45 Other Revenue (DS). Having rolled doubles again, Team C rolls once more and lands on Luxury Tax. No cash payment of $75 is required until they rolls doubles a next time: +$75 Other Expense, +$75 Accounts Payable (DS).

Team A, being effectively broke, rolls the dice. It lands on Chance/Community, and receives $100 from the bank. +$100 Cash, +$100 Other Revenue (DS).

Team B takes a deep collective breath and rolls doubles, going around Go. +$200 Cash, +$200 Go Revenue (DS). Determined to take advantage of the just completed deal with Team A, Team B buys 8 houses at $50 each (four each for Baltic and Mediterranean) for the purple block it now owns. This costs $400: −$400 Cash, +$400 Buildings (LS).

Team B lands on Connecticut Avenue owned by Team C where rent is $8. Team B: −$8 Cash, +$8 Rent Expense (LS) and Team C: +$8 Cash, +$8 Rent Income (DS).

Team B rolls again and lands on St. James owned by Team C, and having a Hotel. Like Team A, Team B does not have much cash at all to part with, so it takes a $1,000 loan from the bank: +$1,000 Cash, +$1,000 Loans Payable-Bank (DS). Team B then pays Team C which has become quite cash rich. Team B: −$950 Cash, +$950 Rent Expense (LS) and Team C: +$950 Cash, +$950 Rent Income (DS).

Team C takes a roll, and goes around Go (+$200 Cash, +$200 Go Revenue) but lands on Income Tax (Pay $200, −$200 Cash, +$200 Other Expense) thereby breaking even on that roll.

At this point, according to the rules of the invention, allotted time has run out; with respect to cash, Teams A and B are broke, and Team C is rich.

In keeping with real world economics, cash position is not the only measure of performance over a period of time or financial condition at any particular point in time. Therefore, according to the invention, financial statements for the teams are prepared from the transactions that resulted from game play. This provides a direct and immediate correlation between the representative picture that such statements provide relative to performance and financial condition. The invention constitutes an excellent learning tool via its capability for generating simulating financial transactions and immediate generation of corresponding financial statements resulting in the participating student being able to immediately draw parallels therebetween—connections that are crucial for understanding such statements in the future.

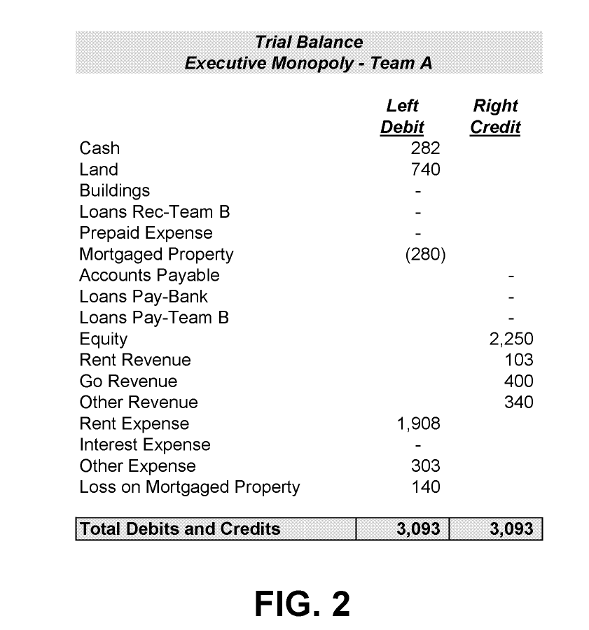

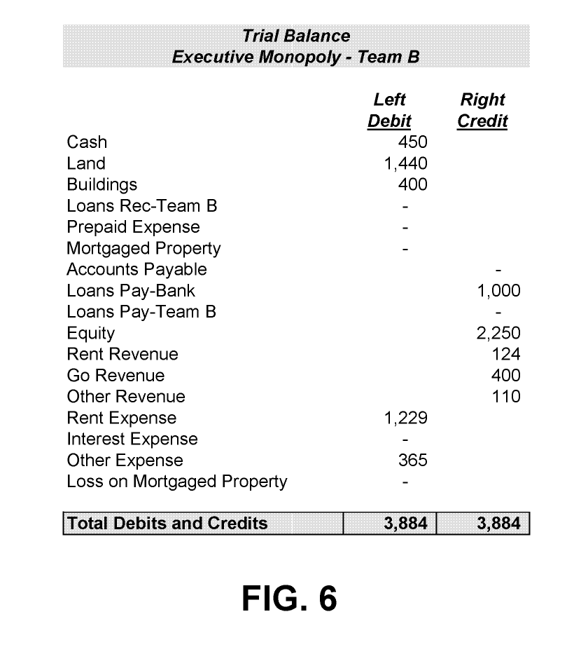

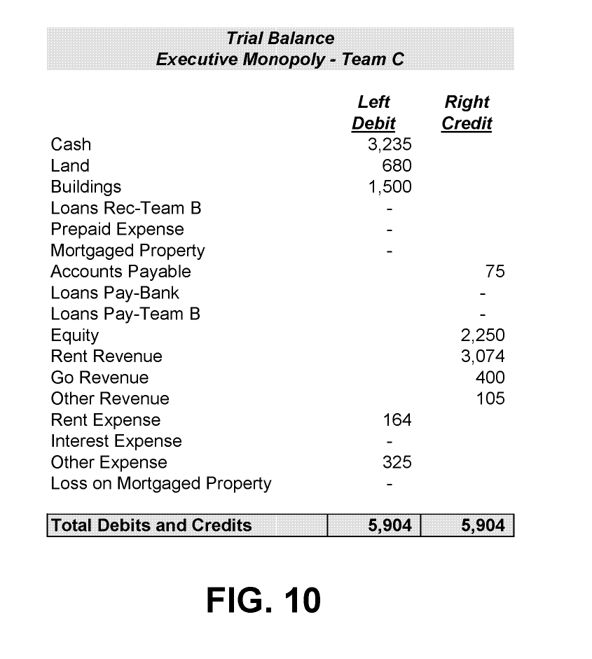

According to the invention, this final step of preparing financial statements resulting from play of the MONOPOLY game facilitates learning and determines a winner of the game. In the example below, determination of the winner is based 50% on Highest Profit and 50% on Greatest Cash Flow (before financing). To this end, the following financial statements are prepared: (1) Trial Balance; (2) Profit & Loss (P&L); (3) Balance Sheet; and (4) Cash Flow Statement. As a step toward the statements' preparation, trial balances for Teams A, B, and C are prepared according to FIGS. 2, 6, and 10, respectively.

The financial statements are automatically prepared in the exemplary computer-based version of the worksheets, and are calculated from data provided via the computerized spreadsheets. When the spreadsheets are completed manually, the financial statements are manually created by the team players.

The trial balance is the first step in creating financial statements. The balance of each account is displayed and whether it is a “debit” or “credit” balance. For a valid trial balance, the sum of all accounts having a debit balance must equal the sum of all accounts having a credit balance. Alternatively, the sum of the debit totals must equal the sum of the credit totals.

In the computerized spreadsheets, each component (account) is depicted as a column. The total for each account is simply the sum of all entries in that column, and appears in the bottom row or cell of the column. It is possible for an account balance to be positive or negative.

According to the invention, the sum of all Left-Side accounts must equal the sum of all Right-Side accounts for a valid trial balance, ignoring “debits” and “credits.” In other words, Left-Side=Right-Side. This is a very intuitive concept which favors quick accounting education.

The balance in the cash account on the computerized spreadsheet must agree with the physical count of actual cash for that player. This is another check on the accuracy of the computerized spreadsheet.

There is also an indication of error in the computerized spreadsheet when a recorded dual-entry does not balance; that is, when it violates the rules for a transaction given above. In this case, the computerized spreadsheet has a cell that changes from a display of “ok” to a display of “error”. This enables the student using the automated tables to quickly know that an error has occurred with the last transaction so that remedial measures may be taken before proceeding.

A Profit & Loss Statement (Revenue minus Expenses) and Balance Sheet (Assets=Liabilities+Equity) are automatically calculated via the data in the computerized spreadsheet.

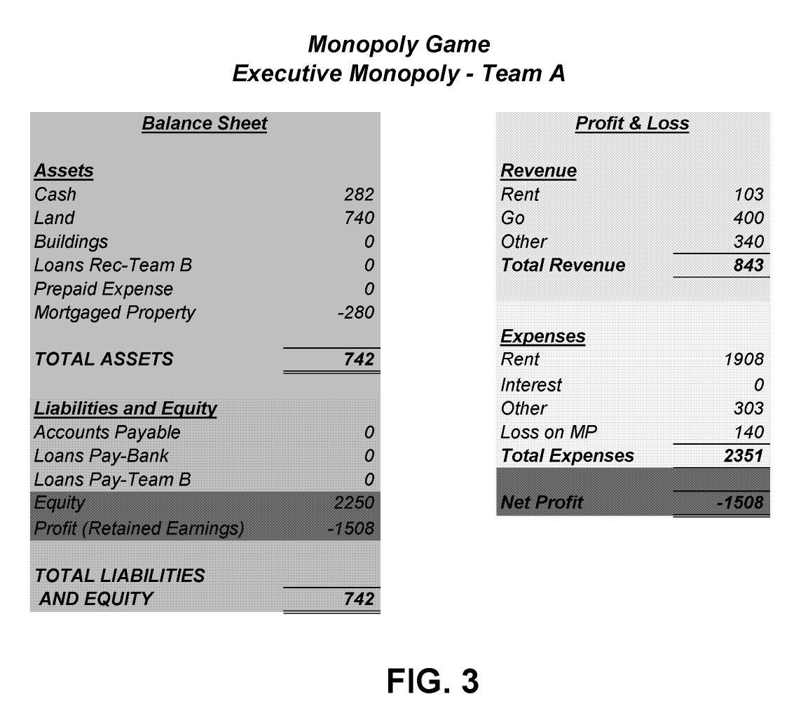

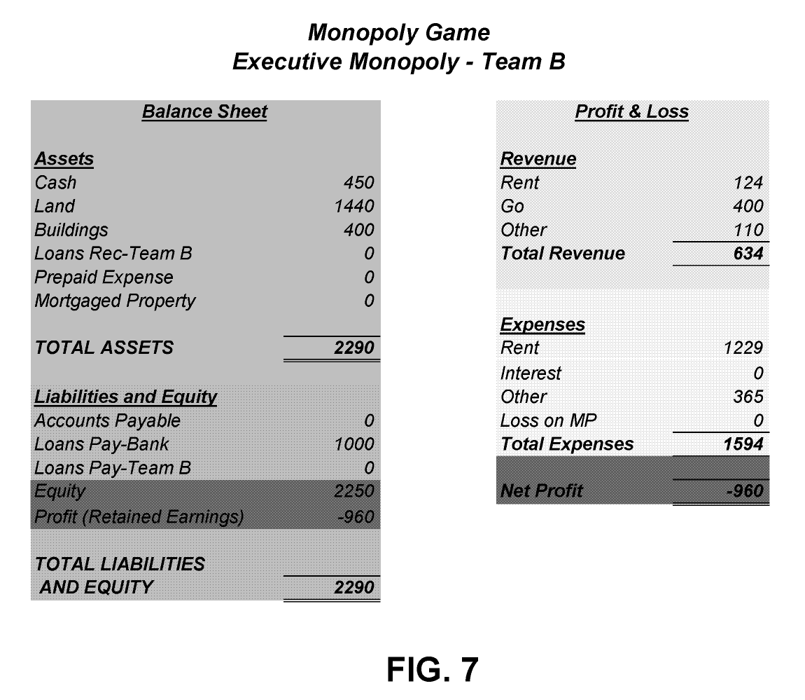

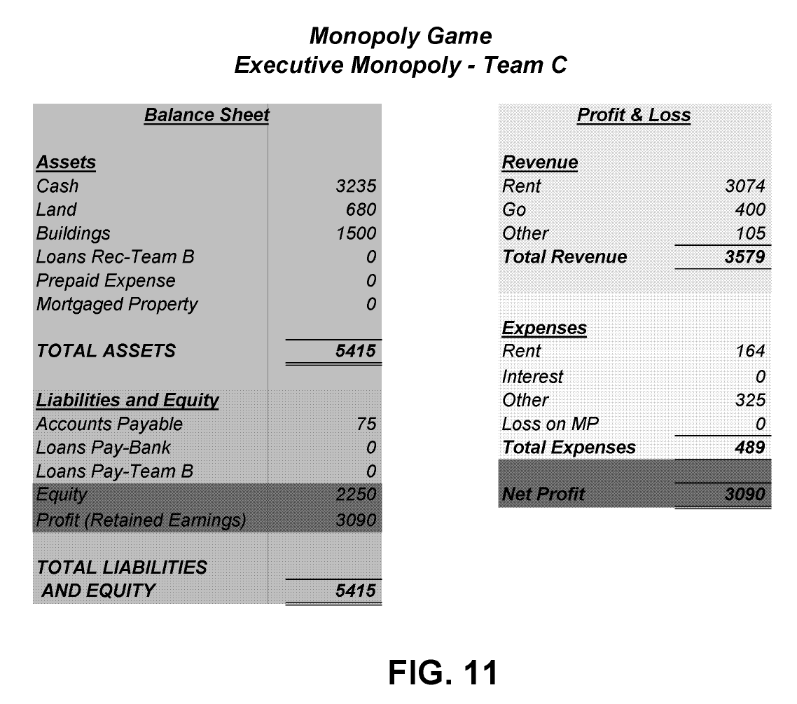

The Profit & Loss Statement and Balance Sheet for Team A, B, and C are shown in FIGS. 3, 7, and 11, respectively. In this way, the performance of each team at playing the MONOPOLY game is scored or quantified in financial statement terms. If performed manually, the account balance for each revenue and each expense account are listed and the total of all revenue accounts is subtracted from the total of all expense accounts to obtain profit & loss using the spreadsheet with hand-written transactions.

The Balance Sheet is created from the accounting formula: Assets=Liabilities+Equity. The Balance Sheet contributes to the scoring of the results of the teams' play indirectly since the creation of the Balance Sheet is required in order to obtain the “cash flow analysis” results. Cash Flow Analysis is part of the scoring of the results of the teams' play of the MONOPOLY game according to the teachings of the present invention. If done manually, the account balance for each asset, each liability, and each equity account balance are listed and the total of all asset accounts must equal the sum of the totals of all liability and equity accounts.

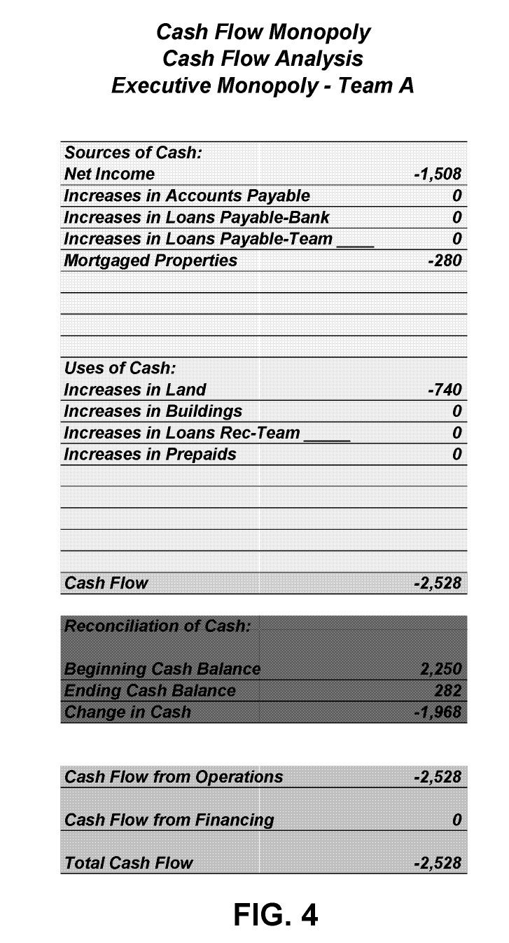

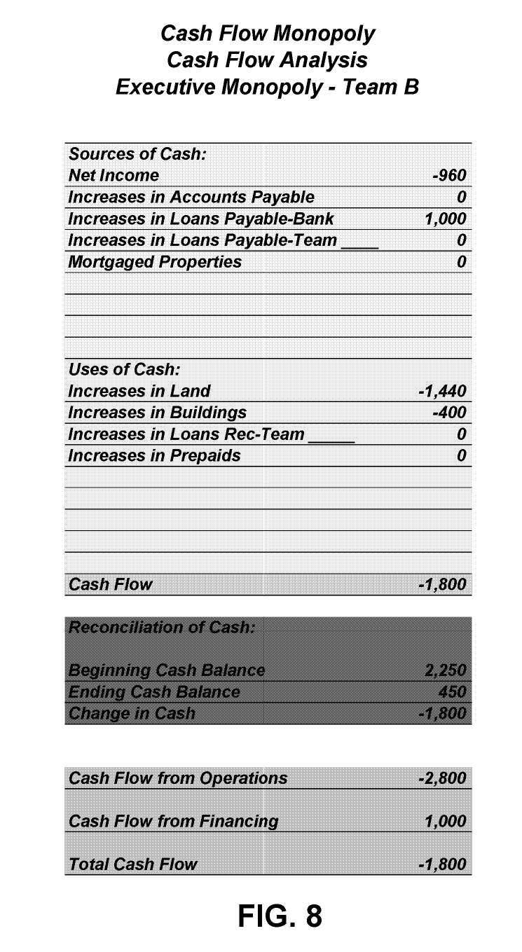

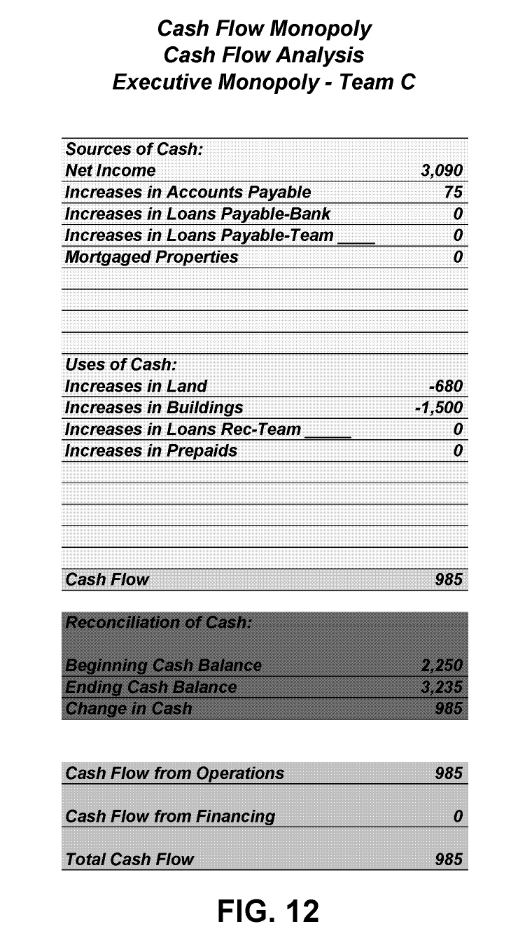

Regarding cash flow analysis, cash flow is equal to the change in cash, or more specifically, the cash balance at the beginning of the game minus the cash balance at the end. The cash flow analysis for Teams A, B, and C are shown in FIGS. 4, 8, and 12, respectively.

The cash flow analysis also displays where cash was collected and where it was spent. In accounting terms, this is called “sources” and “uses” of cash and is typically critical to performance. The inter-relationship may be appreciated as: Sources—Uses of cash=Change in Cash=Cash balance at the beginning of the game minus cash balance at the end of the game. In practice, this means that the change in every account, except the cash account (sources and uses), will be equal to the change in the cash account. These concepts become more clearly focused in the Cash Flow Analysis that is derived from the computerized worksheets.

The invention also establishes and teaches the clear tie between the Accounting Equation and cash flow in an intuitive manner relative to the counter-intuitive teachings of conventional accounting. To this end, a source of cash is treated as an increase in cash; that is, when cash is being received. A use of cash is a decrease in cash; that is, when cash is being spent.

As defined hereinabove with regard to the Accounting Equation, Assets+Expenses (Left Side)=Liabilities+Equity+Revenue (Right Side) with the shorthand notation being: A+E=L+Q+R. Sources and uses of cash are not intuitively easy to understand, and for the non-technical person make it extremely difficult to grasp cash flow. The Accounting Equation makes it easy to look at an account and know whether its change is a “source” or a “use”. The student is taught to simply look at the Accounting Equation and mentally note whether the change in the account is a: +A, −A, +E, −E, +L, −L, +Q, −Q, +R, or −R. Then, once this is known, the student is taught to ask “What cash entry would be required to keep the Accounting Equation in balance?” That determines whether or not there is a source (+cash) or use (−cash).

Referring to the Balance Sheet and Profit and Loss Results for Team A as depicted in FIG. 2, the change in every account, except cash may be examined. All accounts (components) except cash and equity were equal to zero at the start of the game. Land (undeveloped property) increased by $740 representing purchases of Avenues and Streets according to the MONOPOLY game. The student must confront whether this change in Land is a source or use of cash. To answer this, the query of “what cash entry would be required to keep the Accounting Equation in balance” must be considered. Intuitively, even the uninitiated student of financial accounting deduces that an increase of +$740 to Land requires a decrease of −$740 to Cash to balance out (Left-Sided transaction). Therefore, the student easily arrives at the conclusion that an increase in Land is a USE of cash. This is intuitive because cash is spent to purchase Land.

This concept can be made even more simple by characterizing, or categorizing the +$740 Land as just “+A” since Land is an asset. In turn, a “−A” is required to balance the Accounting Equation. Therefore, a decrease in cash is a “−A,” so again the +740 Land purchase is a USE of cash. In this way, any change in any account can be easily traced back to a source or use of cash.

In this way, the invention uses the Accounting Equation to intuitively teach the Statement of Cash Flow, and in the end, to tie the ending cash balance in the worksheet to the actual count of cash at the end of the game. A few examples include the following:

| | | |
|---|---|---|
| +$740 Land | +A Requires −A (LS) | Use of Cash |
| −$280 Mortgaged | −A Requires +A (LS) | Source of Cash |
| Property | | |
| +$843 Revenue | +R Requires +A (DS) | Source of Cash |
| −$2351 Expenses | +E Requires −A (LS) | Use of Cash. |

When converting changes to Sources and Uses for summation, the positive and negative signs are ignored and Sources and Uses are then summed together. Summed sources are positive cash flow, summed uses are negative cash flow, as follows: +$1123 Sources and −$3091 Uses gives a Cash Flow of −$1968. This can be checked as follows: Cash at Start of Game=$2250; Cash at End of Game=$282 and therefore Change in Cash=−$1968 which checks.

The Cash Flow Analysis simplifies Revenue—Expenses to show only the result, or “Profit”, value in FIGS. 4, 8, and 12. Intuitively, a profit is always a “source” of cash and a loss is always a “use” of cash.

What is claimed is:

1. A method for teaching and practicing accounting transactions as an adjunct to playing a game that is based, at least in part, on financial transactions, while avoiding the confusion of traditional debit and credit accounting entry classifications, said method comprising:
engaging in the play of a game in which simulated financial transactions are performed by at least one player; and
recording at least one of the performed simulated financial transactions into a balance-requiring worksheet as a dual-entry, said balance-requiring worksheet having asset and expense accounts balancing against liabilities, equity, and revenue accounts.

2. The method for teaching and practicing accounting transactions as recited in claim 1, further comprising:
checking the accuracy of the recorded dual-entry by taking a difference between each of two component entries of the dual-entry when one component entry is in the asset or expense accounts, and the other component entry is in the liabilities, equity, or revenue accounts and making a summation of each of two component entries of the dual-entry when both component entries are in the asset or expense account, or when both component entries are in the liabilities, equity or revenue accounts; and
providing an indication of accuracy of the dual-entry when the summation or difference equals zero, and providing an indication of an error in the dual-entry when the summation does not equal zero.

3. The method for teaching and practicing accounting transactions as recited in claim 2, further comprising:
providing player feed-back regarding the results of the check on accuracy of the recorded dual-entry.

4. The method for teaching and practicing accounting transactions as recited in claim 3, further comprising:
causing the player to re-record the checked dual-entry when an error is indicated;
re-checking the accuracy of the re-recorded dual-entry and providing player feed-back regarding the results of the re-check on accuracy of the re-recorded dual-entry; and
repeating the steps of re-recording and re-checking until the re-check step determines an indication of accuracy of the dual-entry.

5. The method for teaching and practicing accounting transactions as recited in claim 1, further comprising:
affecting the recordation of the at least one performed simulated financial transactions into a pre-programmed computerized spreadsheet, said spreadsheet programmed to automate treatment of dual-entries, post-recordation.

6. The method for teaching and practicing accounting transactions as recited in claim 1, further comprising:
recording, each as dual-entries, a plurality of performed simulated financial transactions into the balance-requiring worksheet; and
checking the accuracy, post-entry, of the plurality of recorded dual-entries by summing the asset and expense account entries and figuring a difference of that summation against a summation of the liabilities, equity and revenue account entries.

7. The method for teaching and practicing accounting transactions as recited in claim 6, further comprising:
providing an indication of accuracy of the checked plurality of recorded dual-entries when the summation equals zero and providing an indication of error in the checked plurality of recorded dual-entries when the summation does not equal zero.

8. The method for teaching and practicing accounting transactions as recited in claim 7, further comprising:
providing player feed-back regarding the results of the check on accuracy of the plurality of recorded dual-entries.

9. The method for teaching and practicing accounting transactions as recited in claim 8, further comprising:
causing the player to re-record the checked plurality of recorded dual-entries when an error is indicated;
re-checking the accuracy of the re-recorded plurality of dual-entries and providing player feed-back regarding the results of the re-check on accuracy of the re-recorded plurality of dual-entries; and
repeating the steps of re-recording and re-checking until the re-check step determines an indication of accuracy of the re-recorded plurality of dual-entries.

10. The method for teaching and practicing accounting transactions as recited in claim 7, further comprising:
affecting the recordation of each of the plurality of performed simulated financial transactions into a pre-programmed computerized spreadsheet, said spreadsheet programmed to automate treatment of the plurality of dual-entries, post-recordation.

11. The method for teaching and practicing accounting transactions as recited in claim 1, further comprising:
assigning a positive sign to an asset component of a recorded dual-entry when the magnitude of the account in which entry is being made has been increased by the corresponding simulated financial transaction; and
assigning a negative sign to an asset component of a recorded dual-entry when the magnitude of the account in which entry is being made has been decreased by the corresponding simulated financial transaction.

12. The method for teaching and practicing accounting transactions as recited in claim 1, further comprising:
assigning a positive sign to an expense component of a recorded dual-entry when the magnitude of the account in which entry is being made has been increased by the corresponding simulated financial transaction; and
assigning a negative sign to an expense component of a recorded dual-entry when the magnitude of the account in which entry is being made has been decreased by the corresponding simulated financial transaction.

13. The method for teaching and practicing accounting transactions as recited in claim 1, further comprising:
assigning a positive sign to a liability component of a recorded dual-entry when the magnitude of the account in which entry is being made has been increased by the corresponding simulated financial transaction; and
assigning a negative sign to a liability component of a recorded dual-entry when the magnitude of the account in which entry is being made has been decreased by the corresponding simulated financial transaction.

14. The method for teaching and practicing accounting transactions as recited in claim 1, further comprising:
assigning a positive sign to a revenue component of a recorded dual-entry when the magnitude of the account in which entry is being made has been increased by the corresponding simulated financial transaction; and
assigning a negative sign to a revenue component of a recorded dual-entry when the magnitude of the account in which entry is being made has been decreased by the corresponding simulated financial transaction.

15. The method for teaching and practicing accounting transactions as recited in claim 7, further comprising:
selecting the game to be played to be the MONOPOLY game.

16. The method for teaching and practicing accounting transactions as recited in claims 6, further comprising:
affecting the recordation of each of the plurality of performed simulated financial transactions into a pre-programmed computerized spreadsheet, said spreadsheet programmed to automate treatment of the plurality of dual-entries, post-recordation.

17. The method for teaching and practicing accounting transactions as recited in claim 16, further comprising:
configuring the pre-programmed computerized spreadsheet to calculate a balance sheet comprising summations of: asset accounts produced from the recordations of the plurality of dual-entries, liability accounts produced from the recordations of the plurality of recorded dual-entries, and equity accounts produced from the recordations of the plurality of recorded dual-entries; and thereby illustrating, through game play, the formulation of a balance sheet as known in traditional finance.

18. The method for teaching and practicing accounting transactions as recited in claim 16, further comprising:
configuring the pre-programmed computerized spreadsheet to calculate a profit and loss statement comprising a net profit calculated as a difference of a summation of the revenue accounts produced from the recordations of the plurality of dual-entries and a summation of equity accounts produced from the recordations of the plurality of recorded dual-entries; and
thereby illustrating, through game play, the formulation of a profit and loss statement and the calculation of net profit, each as known in traditional finance.

19. The method for teaching and practicing accounting transactions as recited in claim 16, further comprising:
configuring the pre-programmed computerized spreadsheet to calculate a cash flow analysis from the recordations of the plurality of dual-entries.

20. The method for teaching and practicing accounting transactions as recited in claim 16, further comprising:
selecting the game to be played to be the MONOPOLY game;
dividing a plurality of players onto teams and allotting each team a predetermined beginning amount of MONOPOLY game dollars;
initiating play of the MONOPOLY game thereby executing financial transactions; and
causing the entry of each financial transaction executed in the pre-programmed computerized spreadsheet.

21. The method for teaching and practicing accounting transactions as recited in claim 20, further comprising:
determining a winner of the MONOPOLY game based on calculations and a comparison, via the pre-programmed computerized spreadsheet, of net profit for each team.

22. The method for teaching and practicing accounting transactions as recited in claim 20, further comprising:
determining a winner of the MONOPOLY game based on calculations and a comparison, via the pre-programmed computerized spreadsheet, of cash flow for each team.

23. The method for teaching and practicing accounting transactions as recited in claim 1, further comprising:
providing a means for checking the accuracy of the accounts into which the at least one player records each of two component entries of the dual-entry.

24. The method for teaching and practicing accounting transactions as recited in claim 23, further comprising:
providing a human moderator, said human moderator constituting the means for checking the accuracy of the accounts into which the at least one player records each of the two component entries of the dual-entry.
